(19) United States
(12) Patent Application Publication
(10) Pub. No.: US 2008/0041126 A1
(43) Pub. Date: Feb. 21, 2008

(54) First snapping member having indication function

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,721

(22) Filed: Oct. 17, 2007

Related U.S. Application Data
(63) Continuation-in-part of application No. 11/396,696, filed on Apr. 4, 2006.
(63) Continuation-in-part of application No. 10/792,875, filed on Mar. 5, 2004.

(30) Foreign Application Priority Data
Jan. 19, 2004 (TW) 93201051

(51) Int. Cl. E05B 73/00

(52) U.S. Cl. 70/58

(57) ABSTRACT

A strap lock includes a first snapping member, a strap, a second snapping member, a key lock mechanism, a number lock mechanism and an indicator. The strap is connected with the first snapping member. The second snapping member is connected with the strap and detachably connected to the first snapping member. The key lock mechanism is disposed on the first snapping member and is capable of locking or unlocking the second snapping member via a key. The number lock mechanism is disposed on the first snapping member and is capable of locking or unlocking the second snapping member via a code. The indicator is capable of moving to an indication position via the key lock mechanism and of returning to its original position via the number lock mechanism.

### CROSS REFERENCE TO RELATED APPLICATION

This is a continuation-in-part of U.S. patent application Ser. 10/792,875, filed on Mar. 5, 2004, currently pending, and U.S. patent application Ser. 11/396,696, filed on Apr. 4, 2006, currently pending.

### BACKGROUND OF THE INVENTION

1. Field of the Invention

The present invention relates to a strap lock, and more particularly to a double lock having an indication function.

2. Description of the Related Art

A conventional strap lock in accordance with the prior art disclosed in the U.S. Patent Publication No. 2005/0155397 is available for a luggage binding strap which is used to bind a luggage.

A conventional double lock in accordance with the prior art disclosed in the U.S. Pat. No. 6,877,345 comprises a housing, a shackle, a number lock module, a key lock module, and an indicator. The shackle is movably mounted on the housing. The housing has a window for exposing the indicator which presents a first color in the window. When the key lock module is unlocked, the indicator presents a second color in the window so as to remind the user that the key lock module has been unlocked. When the number lock module is unlocked, the indicator is reset to present the first color in the window. However, the conventional padlock needs to provide a shackle.

### SUMMARY OF THE INVENTION

The primary objective of the present invention is to provide a strap lock having two lock modules and an indication function.

Another objective of the present invention is to provide a strap lock, wherein the strap lock has an indication function to remind the user if the strap lock has been unlocked by the specific key held by an inspector of the customs for checking the luggage.

A further objective of the present invention is to provide a strap lock, wherein the strap lock has an indication function without having to provide a shackle that is used in the conventional padlock, thereby enhancing the versatility of the strap lock.

In accordance with one embodiment of the present invention, there is provided a strap lock, comprising a first seat body, a second seat body, a key lock mechanism, a number lock mechanism and an indicator. The second seat body is pivotally mounted on the first seat body. The key lock mechanism is mounted on the first seat body and the number lock mechanism is mounted on the second seat body. The second seat body is lockable by the key lock mechanism and the number lock mechanism and is unlockable by either one of the key lock mechanism and the number lock mechanism. The indicator is mounted on the second lock body. When the number lock mechanism misses a correct code, the indicator is driven by the second seat body to an indication position, and when the number lock mechanism reaches the correct code, the indicator is driven by the second seat body to return to an original position.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a strap lock in accordance with the preferred embodiment of the present invention;

FIG. 2 is a perspective view of a second seat body of a first snapping member of the strap lock as shown in FIG. 1;

FIG. 3 is a perspective assembly view of the strap lock as shown in FIG. 1;

FIG. 4 is a plan cross-sectional view of the strap lock as shown in FIG. 3;

FIG. 5 is a locally enlarged plan cross-sectional view of the strap lock as shown in FIG. 1;

FIG. 6 is a locally enlarged top plan view of the strap lock as shown in FIG. 1;

FIG. 7 is a schematic operational view of the strap lock as shown in FIG. 3;

FIG. 8 is a schematic operational view of the strap lock as shown in FIG. 4;

FIG. 9 is a schematic operational view of the strap lock as shown in FIG. 6;

FIG. 10 is a schematic operational view of the strap lock as shown in FIG. 4;

FIG. 11 is a schematic operational view of the strap lock as shown in FIG. 5;

FIG. 12 is a schematic operational view of the strap lock as shown in FIG. 6; and

FIG. 13 is a schematic operational view of the strap lock as shown in FIG. 12.

### DETAILED DESCRIPTION OF THE INVENTION

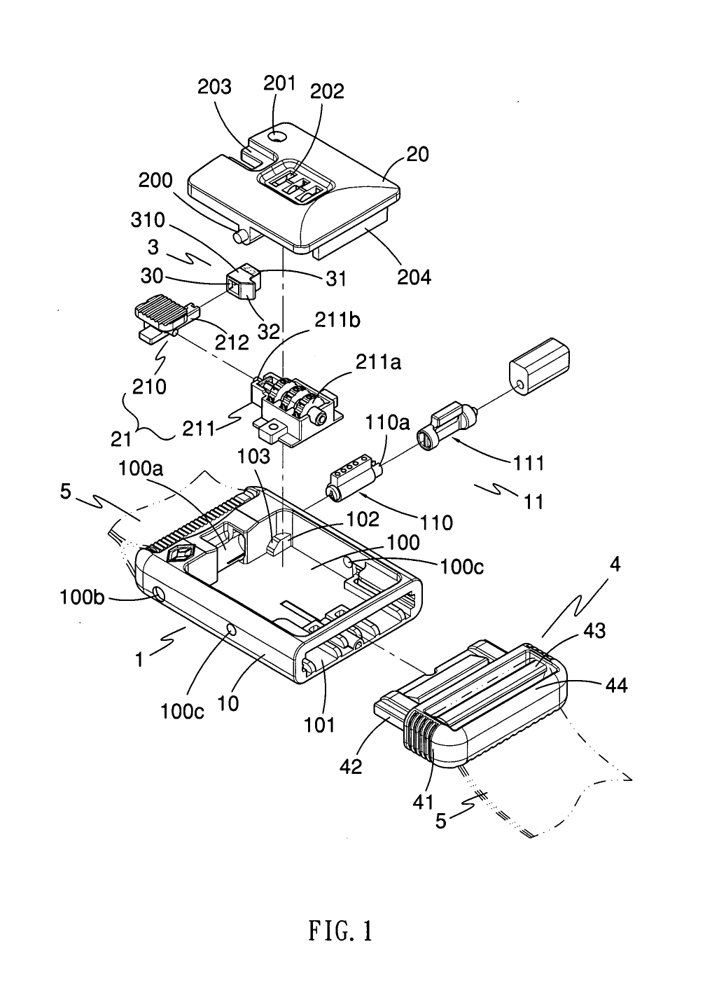

Referring to the drawings and initially to FIG. 1, a strap lock is available for binding a luggage (not shown) in accordance with the preferred embodiment of the present invention. The strap lock includes a first snapping member 1, a second snapping member 4, a key lock mechanism 11, a number lock mechanism 21, and a strap 5. The strap 5 has a first end attached to the second snapping member 4 and a second end attached to the first snapping member 1.

The first snapping member 1 includes a first seat body 10, and a second seat body 20. The first seat body 10 is formed with a receiving recess 100, a breach 100a in communication with the receiving recess 100, an elongated hole 100b in communication with the breach 100a, two opposite shaft holes 100c each in communication with the receiving recess 100, a slot 101 in communication with the receiving recess 100 and located opposite to the breach 100a to allow insertion of the second snapping member 4, and a push block 102 located at a corner between the receiving recess 100 and the breach 100a. The push block 102 has a first ramp 103.

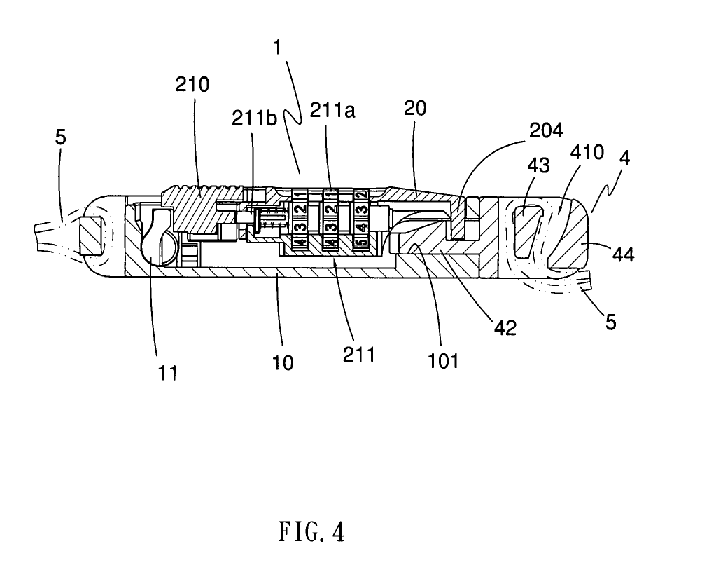

As can be seen in FIGS. 1 and 4, the second snapping member 4 includes a holding portion 41, a tongue 42, a first crossbar 43 and a second crossbar 44. The holding portion 41 defines an interior space 410 therein. The tongue 42 is connected with a front side of the holding portion 41 and detachably buckled into the first snapping member 1. The first crossbar 43 is placed in the space 410 of the holding portion 41. The second crossbar 44 is connected with a rear side of the holding portion 41 and parallel to the first crossbar 43. The strap 5 is fed into space 410 of the holding portion 41 and passes around the first crossbar 43.

The key lock mechanism 11 includes a lock core 110 secured in the elongated hole 100b, and a catch block 111 rotatably disposed in the breach 100a. The lock core 110 has a spindle 110a engaged with the catch block 111. The spindle 110a can be rotated by a specific key (not shown) matching the lock core 110.

The second seat body 20 of the first snapping member 1 is movably disposed in the receiving recess 100 of the first seat body 10. The second seat body 20 has two edges each having a middle portion provided with a shaft 200 pivotally received in the respective shaft hole 100c of the first seat body 10, so that the second seat body 20 is pivotally mounted on the receiving recess 100 of the first seat body 10. The second seat body 20 has a peep hole 201 aligning with the push block 102 of the first seat body 10, a plurality of mounting slots 202 arranged in a serial manner, a slideway 203 aligning with the breach 100a of the first seat body 10, and a locking block 204 aligning with the slot 101 of the first seat body 10.

The number lock mechanism 21 is mounted on the second seat body 20 and includes a push button 210, and a number wheel unit 211. The push button 210 is slidably disposed in the slideway 203 of the second seat body 20 and has a bottom provided with a guide lever 212 located under the peep hole 201 of the second seat body 20. The number wheel unit 211 is mounted on the second seat body 20 and includes a plurality of number wheels 211a rotatably received in the mounting slots 202 of the second seat body 20, and a movable shaft 211b connected to the push button 210.

In operation, the movable shaft 211b is movable axially when the number wheels 211 a are rotated to reach a correct code of the number wheel unit 211, and is fixed and not movable axially when the number wheels 211a are rotated to miss the correct code of the number wheel unit 211.

The indicator 3 has a bottom face facing the push block 102 of the first seat body 10 and a top face having a first portion formed with a first identification zone 31 and a second portion formed with a second identification zone 310. Preferably, the first identification zone 31 of the indicator 3 has a red color, and the second identification zone 310 of the indicator 3 has a green color. The indicator 3 has an inside formed with a mounting hole 30 mounted on the guide lever 212 of the push button 210 so that the indicator 3 is slidable on the guide lever 212 of the push button 210. In addition, the indicator 3 has a side formed with a second ramp 32.

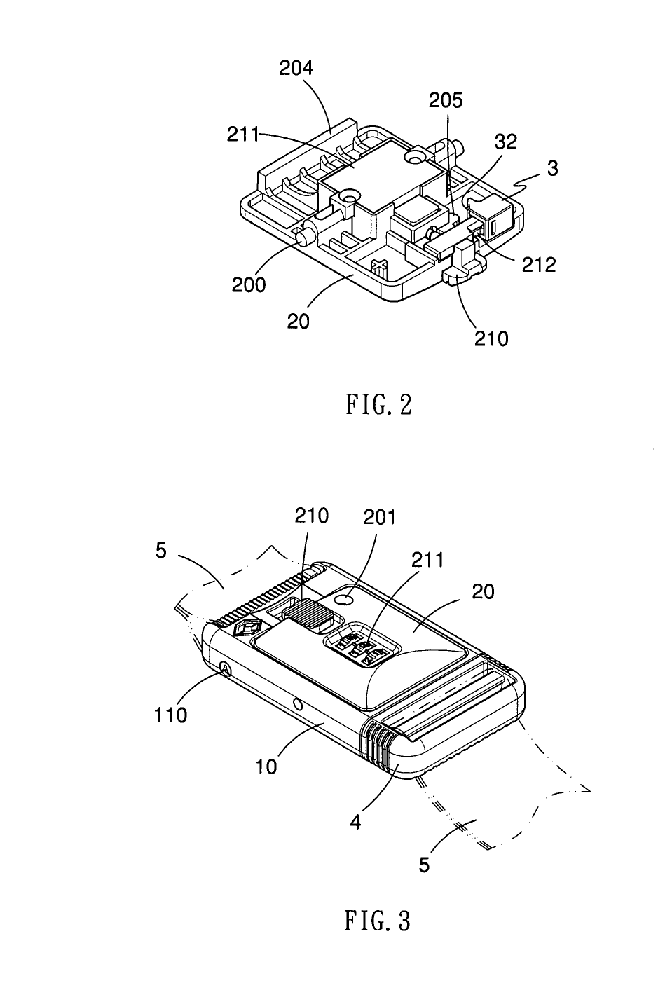

Referring to FIG. 2, the second seat body 20 has a bottom provided with a guide block 205 facing the second ramp 32 of the indicator 3.

Referring to FIGS. 3 and 4, the second snapping member 4 is inserted into the slot 101 of the first seat body 10 and is locked by the locking block 204 of the second seat body 20. At this time, the number wheels 211a of the number wheel unit 211 are rotated to miss the correct code of the number wheel unit 211 so that the movable shaft 211b is fixed and not movable axially. At the same time, the spindle 110a of the lock core 110 is not rotated by the specific key so that the catch block 111 is located at the original position to stop the push button 210 so that the second seat body 20 is fixed and cannot be pivoted. Thus, the second snapping member 4 is locked by the locking block 204 of the second seat body 20 and cannot be detached from the slot 101 of the first seat body 10. In such a manner, the second seat body 20 is locked by the key lock mechanism 11 and the number lock mechanism 21, so that the first snapping member 1 is disposed at a locked state to lock the second snapping member 4 and the strap 5.

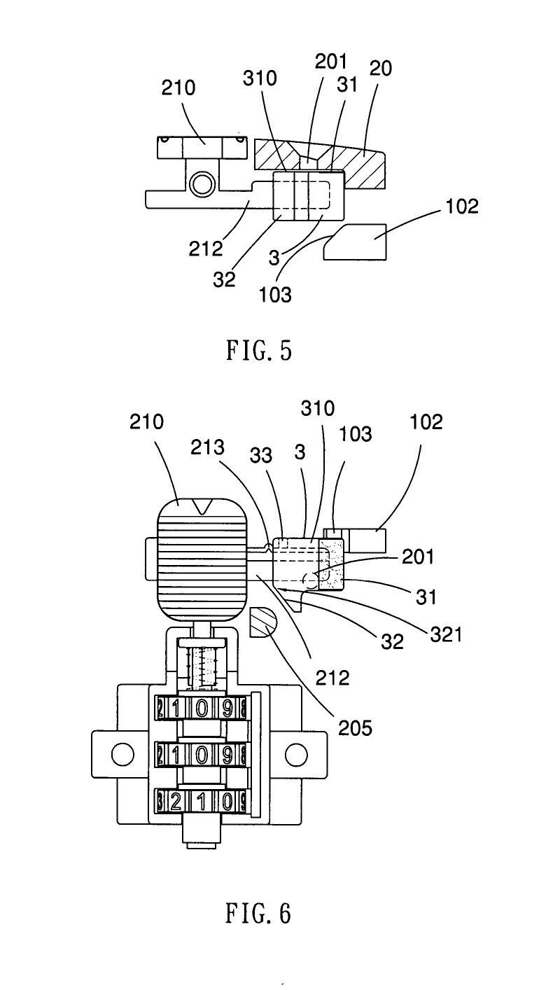

Referring to FIGS. 5 and 6, the indicator 3 and the push button 210 are located at the original position, the peep hole 201 of the second seat body 20 is aligning with the second identification zone 310 of the indicator 3 to present the green color, the first ramp 103 of the push block 102 faces the bottom face of the tail portion of the indicator 3, and the second ramp 32 of the indicator 3 has a first side 321 facing the guide block 205 of the second seat body 20. Thus, when the first snapping member 1 is disposed at the locked state as shown in FIG. 4, the indicator 3 is located at the original position, and the peep hole 201 of the second seat body 20 presents the green color.

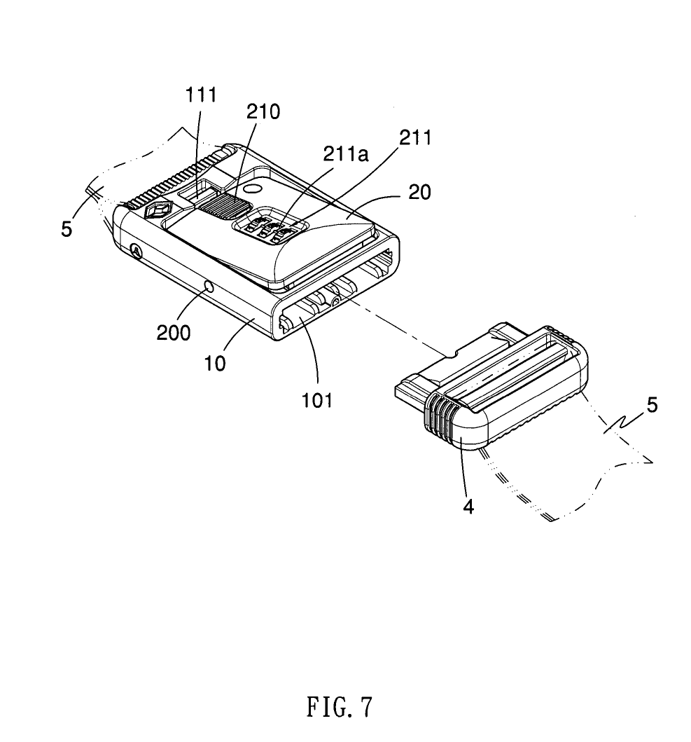

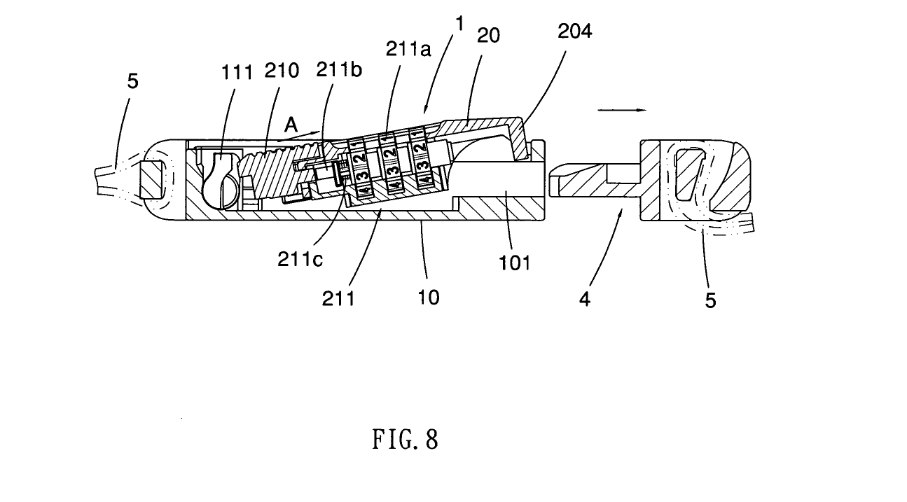

Referring to FIGS. 7 and 8, the number wheels 211a of the number wheel unit 211 are rotated to reach a correct code of the number wheel unit 211, so that the movable shaft 211b is movable axially. At this time, when the push button 210 is pushed in the direction indicated by the arrow “A”, the push button 210 is pushed to detach from the catch block 111, to push the movable shaft 211b and to compress a spring 211c mounted on the movable shaft 211b. Then, the push button 210 is pressed downward, so that the second seat body 20 is pivoted about the shafts 200 to move the locking block 204 upward to release the second snapping member 4 from the locking block 204, thereby removing the second snapping member 4 from the slot 101 of the first seat body 10 of the first snapping member 1 as shown in FIG. 8. Thus, the second seat body 20 is released by the number lock mechanism 21, so that the first snapping member 1 is disposed at a first unlocked state. When the first snapping member 1 is disposed at the first unlocked state, the second snapping member 4 is removed from the slot 101 of the first seat body 10 to release the strap 5. At this time, the spindle 110a of the lock core 110 is not rotated by the specific key to drive the catch block 111 to leave the push button 210. When the force applied on the push button 210 is removed, the movable shaft 211b is pushed and returned to its original position by the restoring force of the spring 211c so as to push the push button 210 to its original position. At the same time, the second seat body 20 is also pushed and returned to the original position by the restoring force of a second spring (not shown).

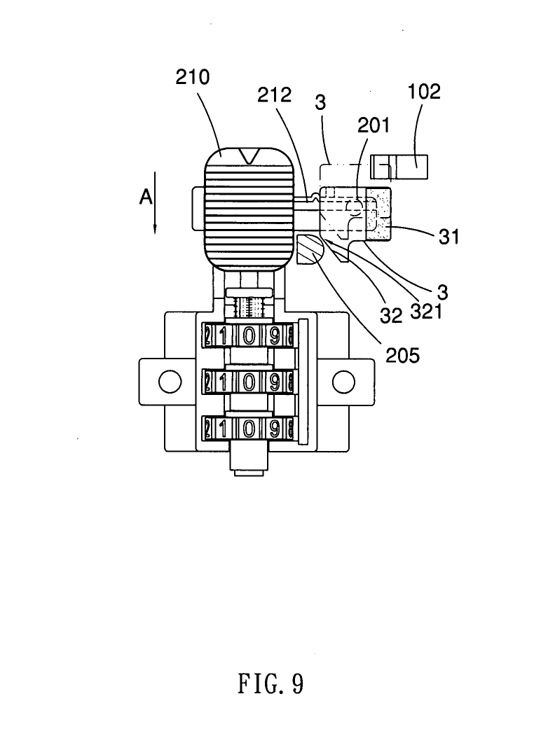

Referring to FIG. 9, the indicator 3 mounted on the guide lever 212 of the push button 210 is movable with the push button 210 in the direction indicated by the arrow “A”. At this time, the first side 321 of the second ramp 32 of the indicator 3 is very close to but does not touch the guide block 205 of the second seat body 20, so that the indicator 3 is not movable along the guide lever 212 of the push button 210. When the indicator 3 is movable with the push button 210 to the position as shown in FIG. 9, the indicator 3 leaves the push block 102, so that even when the indicator 3 moves downward with the push button 210, the indicator 3 will not touch the push block 102. Thus, the indicator 3 is only movable with the push button 210 and is not movable along the guide lever 212 of the push button 210 when the first snapping member 1 is disposed at the first unlocked state. It is to be noted that, the second identification zone 310 of the indicator 3 has a determined width, so that the peep hole 201 of the second seat body 20 presents the green color when the indicator 3 moves with the push button 210 in the direction indicated by the arrow “A” and when the indicator 3 is returned to the original position.

Referring to FIGS. 3-9, when the first snapping member 1 is disposed at the locked state, the peep hole 201 of the second seat body 20 presents the green color. In addition, when the number wheels 211a of the number wheel unit 211 are rotated to reach the correct code of the number wheel unit 211 and the first snapping member 1 is disposed at the first unlocked state, the peep hole 201 of the second seat body 20 presents the green color even when the indicator 3 is movable with the push button 210.

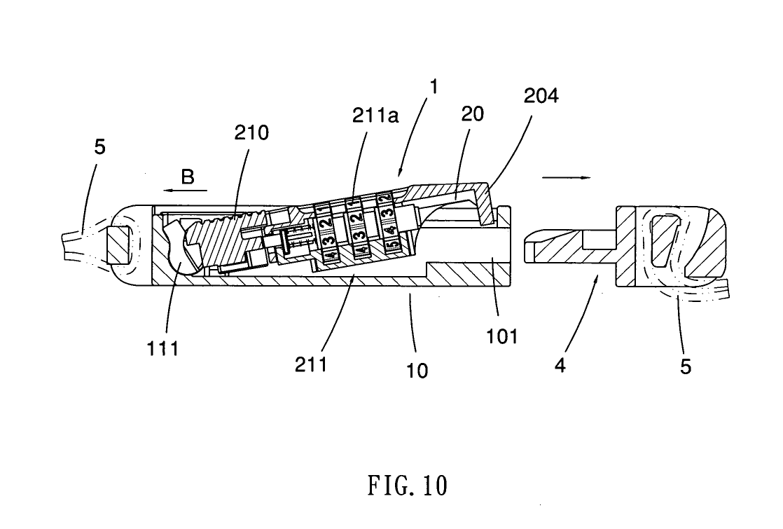

Referring to FIG. 10, the spindle 110a of the lock core 110 is rotated by the specific key so that the catch block 111 is driven to move in the direction indicated by the arrow “B”. At this time, although the number wheels 211a of the number wheel unit 211 are rotated to miss the correct code of the number wheel unit 211 so that the push button 210 cannot be driven to push the catch block 111, the catch block 111 is driven by rotating the specific key to release the push button 210, so that the push button 210 can be pressed downward to pivot the second seat body 20 to move the locking block 204 upward to release the second snapping member 4 from the locking block 204, thereby removing the second snapping member 4 from the slot 101 of the first seat body 10 as shown in FIG. 10. Thus, the second seat body 20 is released by the key lock mechanism 11, so that the first snapping member 1 is disposed at a second unlocked state. When the first snapping member 1 is disposed at the second unlocked state, the second snapping member 4 is removed from the slot 101 of the first seat body 10 to release the strap 5. At this time, even though the number wheels 211a of the number wheel unit 211 are rotated to miss the correct code of the number wheel unit 211 so that the push button 210 cannot be driven to push the catch block 111, the second snapping member 4 can still be removed to release the strap 5.

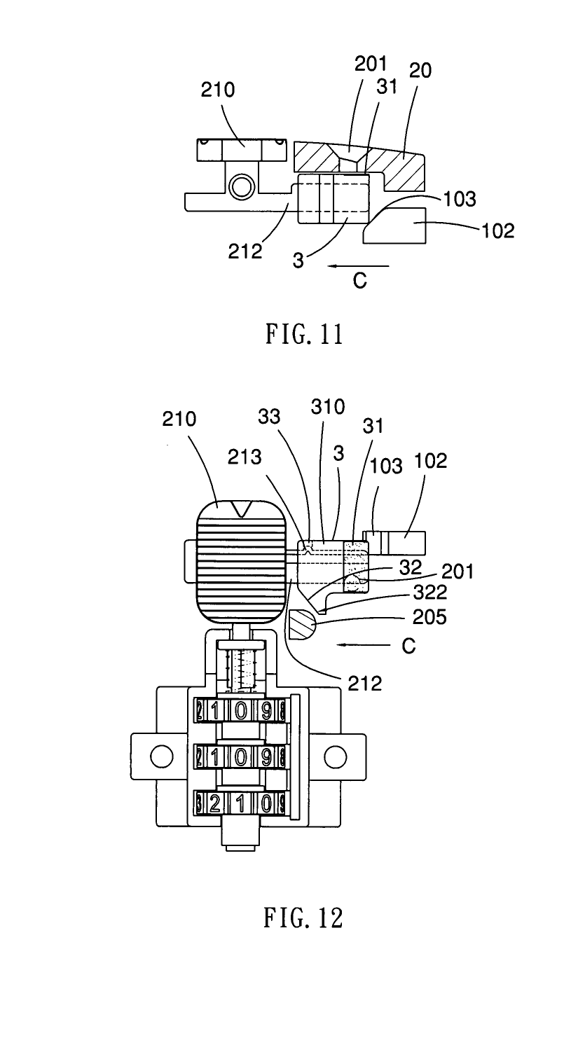

Referring to FIGS. 11 and 12, the first snapping member 1 is disposed at the second unlocked state. At this time, the bottom face of the tail portion of the indicator 3 faces the first ramp 103 of the push block 102. Thus, when the indicator 3 moves downward with the push button 210 to abut the first ramp 103 of the push block 102, the indicator 3 is pushed by the first ramp 103 of the push block 102 and is slidable on the guide lever 212 of the push button 210 in the direction indicated by the arrow “C”, so that the indicator 3 is movable to an indication position as shown in FIGS. 11 and 12. When the indicator 3 is movable on the guide lever 212 of the push button 210 to the indication position, the guide lever 212 of the push button 210 has an elastic boss 213 positioned in a positioning hole 33 of the indicator 3, so that the indicator 3 is positioned on the indication position temporarily. At this time, the second ramp 32 of the indicator 3 has a second side 322 facing the guide block 205 of the second seat body 20, and the peep hole 201 of the second seat body 20 is aligning with the first identification zone 31 of the indicator 3 to present the red color. When the force applied on the push button 210 is removed, the second seat body 20 is pushed and returned to the original position by the restoring force of the second spring (not shown), and the push button 210 is returned to the original position. Then, the catch block 111 is driven by rotating the specific key to return to the original position so as to stop the push button 210. At this time, the peep hole 201 of the second seat body 20 is still aligning with the first identification zone 31 of the indicator 3 to present the red color, which indicates that the first snapping member 1 has been disposed at the second unlocked state.

When in use, the specific key is held by an inspector of the customs, and the first snapping member 1 is disposed at the second unlocked state only when the spindle 110a of the lock core 110 is rotated by the specific key. Thus, when the first snapping member 1 is disposed at the second unlocked state, the peep hole 201 of the second seat body 20 presents the red color to remind the user that the first snapping member 1 has been unlocked by the specific key held by the inspector of the customs.

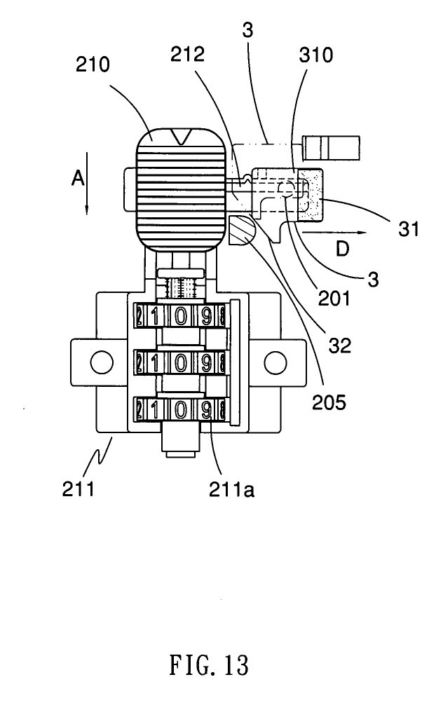

Referring to FIG. 13, after the first snapping member 1 enters the second unlocked state, the number wheels 211a of the number wheel unit 211 are rotated to reach the correct code of the number wheel unit 211, so that the movable shaft 211b is allowed to move axially, and the push button 210 is pushed in the direction indicated by the arrow “A” as shown in FIGS. 7 and 8. When the first snapping member 1 enters the second unlocked state, the indicator 3 is movable to the indication position, the second side 322 of the second ramp 32 of the indicator 3 faces the guide block 205 of the second seat body 20 as shown in FIG. 12. Thus, when the push button 210 is pushed in the direction indicated by the arrow “A” as shown in FIG. 13, the second ramp 32 of the indicator 3 is pushed by the guide block 205 of the second seat body 20, so that the indicator 3 is movable on the guide lever 212 of the push button 210 in the direction indicated by the arrow “D” as shown in FIG. 13 to return to the original position until the peep hole 201 of the second seat body 20 is aligning with the second identification zone 310 of the indicator 3 to present the green color. It is to be noted that, after the first snapping member 1 enters the second unlocked state (that is, the second seat body 20 is released by the key lock mechanism 11), the indicator 3 is returned to the original position and the peep hole 201 of the second seat body 20 presents the green color only when the first snapping member 1 enters the first unlocked state (that is, the number wheels 211a of the number wheel unit 211 are rotated to reach the correct code of the number wheel unit 211).

In conclusion, when the first snapping member 1 enters the second unlocked state (that is, the second seat body 20 is released by the key lock mechanism 11, and the number wheels 211 a of the number wheel unit 211 are rotated to miss the correct code of the number wheel unit 211), the indicator 3 is driven by the second seat body 20 to the indication position, and when the first snapping member 1 enters the first unlocked state (that is, the number wheels 21 la of the number wheel unit 211 are rotated to reach the correct code of the number wheel unit 211), the indicator 3 is driven by the second seat body 20 to return to the original position. More specifically, when the number lock mechanism 21 misses the correct code, the indicator 3 is driven by the number lock mechanism 21 to the indication position, and when the number lock mechanism 21 reaches the correct code, the indicator 3 is driven by the number lock mechanism 21 to return to the original position.

Accordingly, the strap lock of the present invention has an indication function to remind the user if the strap lock has been unlocked by the specific key held by an inspector of the customs for checking the luggage. In addition, the strap lock has an indication function without having to provide a shackle that is used in the conventional padlock, thereby enhancing the versatility of the strap lock.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A strap lock comprising:
a first snapping member;
a strap connected with the first snapping member;
a second snapping member connected with the strap and detachably connected to the first snapping member;
a key lock mechanism disposed on the first snapping member and being capable of locking or unlocking the second snapping member via a key;
a number lock mechanism disposed on the first snapping member and being capable of locking or unlocking the second snapping member via a code; and
an indicator capable of moving to an indication position via the key lock mechanism, and of returning to its original position via the number lock mechanism.

2. The strap lock of claim 1, wherein the key lock mechanism comprises a lock core operable by the key, and a catch hook which can be driven by the lock core to abut against or depart from the number lock mechanism.

3. The strap lock of claim 2, wherein the number lock mechanism comprises a push button that can be driven to abut against or depart from the catch hook of the key lock mechanism when the code of the number lock mechanism is entered.

4. The strap lock of claim 1, wherein the first snapping member comprises:
a first seat body; and
a second seat body movably mounted on the first seat body wherein movement of the second seat body is controlled by either one of the key lock mechanism and the number lock mechanism.

5. The strap lock of claim 4, wherein the key lock mechanism is disposed on the first seat body and the number lock mechanism is disposed on the second seat body.

6. The strap lock of claim 5, wherein the key lock mechanism comprises a lock core operable by the key, and a catch hook driven by the lock core to abut against or depart from the number lock mechanism.

7. The strap lock of claim 6, wherein the number lock mechanism comprises a push button which can be driven to abut against or depart from catch hook of the key lock mechanism when the code of the number lock mechanism is entered.

8. The strap lock of claim 1, wherein the second snapping member comprises:
a holding portion defining an interior space therein;
a tongue connected with a front side of the holding portion and detachably buckled into the first snapping member;
a first crossbar placed in the space of the holding portion; and
a second crossbar connected with a rear side of the holding portion and parallel to the first crossbar;
wherein the strap is fed into space of the holding portion and passes around the first crossbar.

9. A lock comprising:
a first seat body;
a second seat body movably mounted on the first seat body;
a key lock mechanism disposed on the first seat body; and
a number lock mechanism disposed on the second seat body; wherein movement of the second seat body is controlled by either one of the key lock mechanism and the number lock mechanism; and
an indicator capable of moving to an indication position via the key lock mechanism, and of returning to its original position via the number lock mechanism.

10. The lock of claim 9, wherein the key lock mechanism comprises a lock core operable by a key, and a catch hook driven by the lock core to abut against or depart from the number lock mechanism.

11. The lock of claim 10, wherein the number lock mechanism comprises a push button that can be driven to abut against or depart from the catch hook of the key lock mechanism when the code of the number lock mechanism is entered.

12. The lock of claim 11 comprising a snapping member detachably connected with the first seat body.

13. A strap lock comprising:
a first snapping member;
a strap connected with the first snapping member;
a second snapping member connected with the strap and detachably connected to the first snapping member;
a lock mechanism configured for locking or unlocking the second snapping member via two different ways; and
an indicator capable of moving to an indication position via one of the two ways, and of returning to its original position via the other way.

14. The strap lock of claim 13 wherein the lock mechanism includes a key lock mechanism and a number lock mechanism; the second snapping member can be locked in or unlocked from the first snapping member by either one of the key lock mechanism and the number lock mechanism, and the indicator is able to move to the indication position by operating the key lock mechanism via a key and return to its original position by setting a code to the number lock mechanism.
